(19) United States
(12) Patent Application Publication
(10) Pub. No.: US 2019/0327094 A1
(43) Pub. Date: Oct. 24, 2019

(54) INFORMATION AUTHENTICATION METHOD AND SYSTEM

(71) Applicant: ZhongAn Information Technology Service Co., Ltd., Shenzhen (CN)

(72) Inventors: Haibin KAN, Shenzhen (CN); Jie WEN, Shenzhen (CN); Baixiang LIU, Shenzhen (CN); Bin TAN, Shenzhen (CN); Sixian ZHANG, Shenzhen (CN); Xuefeng LI, Shenzhen (CN); Huanyu MA, Shenzhen (CN)

(21) Appl. No.: 16/459,751

(22) Filed: Jul. 2, 2019

Related U.S. Application Data
(63) Continuation of application No. PCT/CN2018/095430, filed on Jul. 12, 2018.

(30) Foreign Application Priority Data
Jul. 14, 2017 (CN) 201710576913.1

(51) Int. Cl. H04L 9/32; G06F 16/23

(52) U.S. Cl. CPC H04L 9/3236; G06F 16/2365; G06F 16/2308

(57) ABSTRACT

Embodiments of the present application discloses an information authentication method, which includes: generating first transaction information based on content information of first information to be published by an original information publishing end and a HASH value of the first information, wherein the first information is original information or a copy of the original information; writing the first transaction information into a central database and Blockchain, or into the Blockchain; obtaining reprinted information published by an information reprinting end, and generating a HASH value of the reprinted information; comparing the HASH value of the first information with the HASH value of the reprinted information; and returning a first credential, which indicates the reprinted information is true or has not been tampered with, to the information reprinting end, if the HASH value of the first information is equal to the HASH value of the reprinted information.

### CROSS-REFERENCE TO RELATED APPLICATIONS

The present application is a continuation of international application No. PCT/CN2018/095430 filed on Jul. 12, 2018, which claims priority to Chinese patent application No. 201710576913.1, filed on Jul. 14, 2017. Both applications are incorporated herein in their entireties by reference.

### TECHNICAL FIELD

The present application relates to the technical field of information science, and more particularly, to a method and system for information authentication.

### BACKGROUND

With the rapid development of information science and network technology, more and more people are exposed to the Internet. In 2010, the number of Chinese netizens was 457.3 million. As of the end of 2016, the number of Chinese netizens reached 648.75 million, achieving a growth of nearly 200 million people in four years. From the perspective of the number of netizens, China is the largest country in the network undoubtedly.

The huge number of netizens leads to the wide spread of more and more information on the Internet, and the amount of information generated by major social media increasing at PB (Petabyte) level. Since the Internet information is mostly published under a non-real name system, together with the complexity of netizens composition, conditions for the breeding and spread of Internet rumors are provided undoubtedly.

Weibo reporting backend obtains 5.19 million reports on untrue information in 2016. WeChat Security Center published that, within only one month, rumor information in August 2015 increased by 13.9% comparing with that in July. In 2016, the rumor refuting center of WeChat public platform penalized 100,000 accounts that involve in fabricating and spreading rumors. The manually screening of such a huge number of rumors is impossible, which brings supervision tremendous pressure, and a reliable and automatic method of identification must be found.

In order to improve its sense of reality, a plurality of rumors may be added reprinted sources usually of authoritative bodies. This problem may be solved from aspects of certification and traceability, and the authenticity of news being browsed may be determined by comparing the news being browsed with original news.

### SUMMARY

In view of what mentioned above, embodiments of the present application provide an information authentication method and information authentication system to solve the problems of data volume being huge, easy to be tampered with, vulnerable to attacks in the traditional authentication method.

According to an aspect of the embodiments of the present application, an information authentication method is provided, which includes: generating first transaction information based on content information of first information to be published by an original information publishing end and a HASH value of the first information, the first information is original information or a copy of the original information; writing the first transaction information into a central database and Blockchain, or into the Blockchain; obtaining reprinted information published by an information reprinting end, and generating a HASH value of the reprinted information; comparing the HASH value of the first information with the HASH value of the reprinted information; and returning a first credential, which indicates the reprinted information is true or has not been tampered with, to the information reprinting end, if the HASH value of the first information is equal to the HASH value of the reprinted information.

According to an embodiment of the present application, before generating first transaction information based on content information of first information to be published by an original information publishing end and a HASH value of the first information, the method further includes: obtaining the first information to be published by the original information publishing end; extracting the content information of the first information; and generating the HASH value of the first information; the method further includes: returning a second credential, which indicates the reprinted information is untrue or has been tampered with, to the information reprinting end, or skipping returning any credential, if the HASH value of the first information is unequal to the HASH value of the reprinted information.

According to an embodiment of the present application, the obtaining reprinted information published by an information reprinting end, and generating a HASH value of the reprinted information further includes: extracting content information of the reprinted information based on the reprinted information; after the generating a HASH value of the reprinted information, the method further includes: generating second transaction information from the HASH value of the reprinted information and the content information of the reprinted information; writing the second transaction information into the central database and the Blockchain, or into the Blockchain.

According to an embodiment of the present application, the method further includes: writing entire content of the first transaction information or the second transaction information into the Blockchain, when writing the first transaction information or the second transaction information into the Blockchain; writing entire content of the first transaction information into the central database and writing the HASH value in the first transaction information and an ID in the first transaction information into the Blockchain, or writing entire content of the second transaction information into the central database and writing the HASH value in the second transaction information and an ID in the second transaction information into the Blockchain, when writing the first transaction information or the second transaction information into the Blockchain and the central database.

According to an embodiment of the present application, the second transaction information further includes a HASH value of a parent transaction of the reprinted information.

According to an embodiment of the present application, the method further includes: extracting the first transaction information of the first information corresponding to the reprinted information, when the first credential is accessed.

According to an embodiment of the present application, the method further includes: obtaining terminal information from an information reading end, and generating a HASH value of the terminal information; comparing the HASH value of the terminal information with the HASH value of the first information; and returning a third credential, which indicates the terminal information is true or has not been tampered with, to the information reading end, if the HASH value of the terminal information is equal to the HASH value of the first information.

According to an embodiment of the present application, the method further includes: returning a fourth credential, which indicates the terminal information is untrue or has been tampered with, to the information reading end, or skipping returning any credential, if the HASH value of the terminal information is unequal to the HASH value of the first information.

According to an embodiment of the present application, the method further includes: extracting, from the central database or the Blockchain, the second transaction information of the reprinted information corresponding to the terminal information, when the third credential is accessed.

According to an embodiment of the present application, the first credential and the third credential are represented as a two-dimensional code.

According to an embodiment of the present application, the content information includes: at least one of an ID, a title, content, an author, a date, and a posting site name of information.

According to another aspect of the embodiments of the present application, an embodiment of information authentication system is provided, which includes: an generating module, configured to generate first transaction information based on content information of first information to be published by an original information publishing end and a HASH value of the first information, the first information is original information or a copy of the original information; a writing module, configured to write the first transaction information generated by the generating module into a central database and Blockchain, or into the Blockchain; an obtaining module, configured to obtain reprinted information published by an information reprinting end, and generate a HASH value of the reprinted information; a comparing module, configured to compare the HASH value of the first information with the HASH value of the reprinted information; and a returning module, configured to return a first credential, which indicates the reprinted information is true or has not been tampered with, to the information reprinting end, if the HASH value of the first information is equal to the HASH value of the reprinted information.

According to an embodiment of the present application, the obtaining module is further configured to obtain the first information to be published by the original information publishing end, extract the content information of the first information, and generate the HASH value of the first information; the returning module is further configured to return a second credential, which indicates the reprinted information is untrue or has been tampered with, to the information reprinting end, or skip returning any credential, if the HASH value of the first information is unequal to the HASH value of the reprinted information.

According to an embodiment of the present application, the obtaining module is further configured to extract content information of the reprinted information based on the reprinted information; the generating module is further configured to generate second transaction information from the HASH value of the reprinted information and the content information of the reprinted information; and the writing module is further configured to write the second transaction information into the central database and the Blockchain, or into the Blockchain.

According to an embodiment of the present application, the writing module is configured to write entire content of the first transaction information or the second transaction information into the Blockchain, when writing the first transaction information or the second transaction information into the Blockchain; the writing module is configured to write entire content of the first transaction information into the central database and write the HASH value in the first transaction information and an ID in the first transaction information into the Blockchain, or write entire content of the second transaction information into the central database and write the HASH value in the second transaction information and an ID in the second transaction information into the Blockchain, when writing the first transaction information or the second transaction information into the Blockchain and the central database.

According to an embodiment of the present application, the second transaction information further includes a HASH value of a parent transaction of the reprinted information.

According to an embodiment of the present application, the extracting module is configured to extract the first transaction information of the first information corresponding to the reprinted information, when the first credential is accessed.

According to an embodiment of the present application, the obtaining module is further configured to obtain terminal information from an information reading end, and generate a HASH value of the terminal information; the comparing module is further configured to compare the HASH value of the terminal information with the HASH of the first information; and the returning module is further configured to return a third credential, which indicates the terminal information is true or has not been tampered with, to the information reading end, if the HASH value of the terminal information is equal to the HASH value of the first information.

According to an embodiment of the present application, the returning module is further configured to return a fourth credential, which indicates the terminal information is untrue or has been tampered with, to the information reading end, or skip returning any credential, if the HASH value of the terminal information is unequal to the HASH value of the first information.

According to an embodiment of the present application, the extracting module is further configured to extract, from the central database or the Blockchain, the second transaction information of the reprinted information corresponding to the terminal information, when the third credential is accessed.

According to an embodiment of the present application, the first credential and the third credential are represented as a two-dimensional code.

According to an embodiment of the present application, the content information includes at least one of an ID of information, a title of the information, a content of the information, an author of the information, a date of the information, and a posting site name of the information.

According to embodiments of the present application, a computer device is provided, which includes a processor; and a memory storing a computer program that, when executed by the processor, cause the processor to perform the information authentication method as above.

According to embodiments of the present application, a computer readable storage medium is provided, which stores a computer program that, when executed by the processor, cause the processor to perform the information authentication method as above.

An information authentication method provided by an embodiment of the present application, based on the Blockchain, by writing the HASH value and the content information of the original information or the copy of the original information (the first information) into the Blockchain as the first transaction information, using the characteristics of the Blockchain of distributed storage, decentralization, traceability, immutability and the like, it may be ensured that the HASH value and content information of the first information are permanently and reliably stored and immutability. In some embodiments of the present application, the HASH value of the reprinted information is compared with the HASH value storing the first information so as to determine if the reprinted information is consistent with the first information released by the original information publishing end, and therefore an efficient and reliable information authentication of the reprinted information is achieved. . In summary, the information authentication method and system provided by the embodiments of the present application have the following advantages and beneficial effects:

(1) By accomplishing information authentication and traceability reliably and efficiently, it may realize recording, matching, tracing, verification and authenticity identification of news.

(2) Based on traceability of Blockchain, it has the advantages of immutability, decentralized, difficult to attack, small amount of data storage and fast.

(3) It may be used to overcome the shortcomings of Internet media information that can not be traced and be verified, the authenticity, record chains of the news communication, and compare between old and new information to confirm the falsification.

(4) It makes the news or information of the Internet social media can be traced, confirmed and falsified.

(5) It may be used not only for the source tracing of news, but also on fields such as food safety, vaccine traceability, luxury goods protection and the like.

### BRIEF DESCRIPTION OF DRAWINGS

FIG. 1 is a flow chart showing an information authentication method according to an embodiment of the present application;

FIG. 2 is a flow chart showing an information authentication method according to another embodiment of the present application;

FIG. 3 is a flow chart showing an information authentication method according to another embodiment of the present application;

FIG. 4 is a flow chart showing specific operation of an original information publishing end and that of an information reprinting end according to another embodiment of the present application;

FIG. 5 is a flow chart showing specific operation of an information reading end according to another embodiment of the present application;

FIG. 6 is a schematic diagram illustrating partial transaction information obtained by an information authentication system after the information authentication system runs and accesses a first credential and a third credential, according to another embodiment of the present application;

FIG. 7 is a schematic diagram illustrating a credential generated by an information authentication system at its runtime according to an embodiment of the present application;

FIG. 8 is a schematic diagram illustrating a running result of an information authentication system on an information reading end, according to an embodiment of the present application;

FIG. 9 is a schematic structural diagram of an information authentication system according to an embodiment of the present application;

FIG. 10 is a schematic structural diagram of an information authentication system according to an embodiment of the present application.

### DETAILED DESCRIPTION

In order to make the objects, technical means and advantages of the present application clearer, the present application will be further described below in detail with reference to the accompanying drawings.

To those skilled in the art, it's understood that Blockchain is of a chained data structure in which data blocks are sequentially connected in a chronological order. And the Blockchain is a distributed ledger which may not be tampered with and are unforgeable, guaranteed by cryptography. In a broad sense, Blockchain technology is a completely new distributed infrastructure and computing paradigm, which uses the chained Blockchain data structure to verify and store data, uses distributed node consensus algorithm to generate and update data, uses cryptography to ensure security of data transmission and access, and uses a smart contract consisted of automated script codes to program and manipulate data. At first

Blockchain format is used in bitcoin, as a solution to solve a problem of database security and with no need for a trusted administrator. The first Blockchain was conceptualized by Satoshi Nakamoto in 2008 and implemented as a core component of digital currency, i.e., bitcoin, in the next year, and serves as the public ledger for all transactions. The database of Blockchain is managed autonomously by using a peer-to-peer network and a distributed timestamp server. The invention of Blockchain in the bitcoin has made the bitcoin the first digital currency as a solution to the double spending problem.

Embodiments of the present application provide a reliable and efficient information authentication method and system by utilizing the characteristics of the Blockchain, such as distributed storage, decentralization, traceability and being immutability.

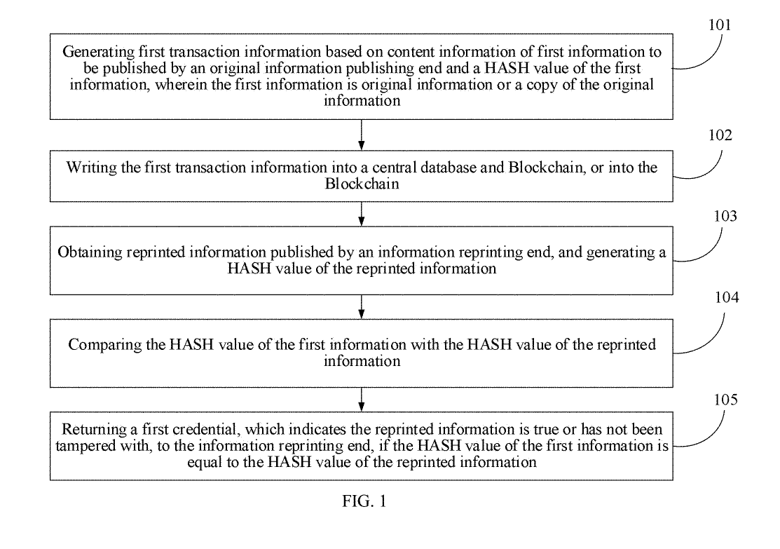

FIG. 1 is a flow chart showing an information authentication method according to an embodiment of the present application. A method shown in FIG.1 is executed by a node (for example, a server or a network device) based on the Blockchain. As shown in FIG. 1, the information authentication method may include the following steps.

101: Generating first transaction information based on content information of first information to be published by an original information publishing end and a HASH value of the first information, wherein the first information is original information or a copy of the original information.

The original information publishing end, for example, may be major news media, websites or the like, and there may be one or a plurality of original information publishing ends. The first information obtained is the original information, when the original information publishing end is one. The first information obtained is usually the copy of the original information, when there are a plurality of the original information publishing ends.

A HASH value may be obtained by processing information with HASH algorithm, and different information may be of different HASH value. Comparing to the information corresponding to the HASH value, the HASH value takes up very small storage space. And thus the HASH value is suitable for the retrieval and comparing of large chunks of information, for example, the traceability, verification and authenticity of news, as well as information certification and traceability in the fields such as food safety, vaccine traceability, luxury goods protection and the like.

The content information generally includes at least one of an ID of information, a title of the information, a content of the information, an author of the information, a date of the information, and a posting site name of the information. The ID of the information may include an original link address of the information. The content information can be searched in coordination with the HASH value to improve the retrieval efficiency, and be saved to record the first information for further viewing and verification.

102: Writing the first transaction information into the central database and the Blockchain, or into the Blockchain.

In some embodiments of the present application, for the storage of the first transaction information, the following modes may be selected. 1. Weak centralization mode, in which the first information is written into the central database and the Blockchain. The weak centralization mode provides two options which include: (a) multiple information publishing events are written into one transaction; (b) one information publishing event is written into one transaction, and only abstract of the first transaction information was written. 2. Decentralization mode, in which the entire content of the first transaction information is written into the Blockchain directly.

When the first transaction information is written into the Blockchain and the central database, the entire content of the first transaction information may be written into the central database, and the HASH value in the first transaction information and the ID in the first transaction information are written into the Blockchain. At the same time, the central database alleviates the storage pressure of the content information other than the ID. Meanwhile, since the ID usually occupies a small storage space and is important for searching for information, the ID of the first information together with the HASH value of the first transaction information are stored in the Blockchain for permanent storage, which is also convenient for tracing information. For example, as an original information publishing end publishes first information, the HASH value of the first information and the ID of the first information will be permanently recorded, so that the version information published by the different original information publishing end may be saved in the mechanism.

When writing the first transaction information into the block chain, the entire content of the first transaction information is written into the Blockchain, and thus not only the storage of the HASH value of the first transaction information is realized, but also the content information of the first transaction information is recorded permanently.

103: Obtaining reprinted information published by an information reprinting end; and generating a HASH value of the reprinted information.

The information reprinting end usually may attach the reprinted source when reprinting the information published by the original information publishing end, or some information reprinting ends will attach the reprinted source that is usually of the authoritative body when publishing false information for some purpose. The reprinted sources may usually be searched for a match in the content information of the first information, so that the retrieval range may be quickly locked out from the Blockchain or the central database and the first information corresponding to the reprinted information may be determined.

Same as the method of acquiring the HASH value of the first information, the HASH value of the reprinted information may also be obtained by the HASH algorithm.

104: Comparing the HASH value of the first information with the HASH of the reprinted information.

105: Returning a first credential that the information is true or has not been tampered with to the information reprinting end, if the HASH value of the first information is equal to the HASH value of the reprinted information.

Since different information may result in different HASH value, when the HASH value of the reprinted information is compared with the HASH value of the first information, and the result shows their HASH values are identical. That is to say, the information reprinted on the information reprinting end is identical to the first information published by the original information publishing end. In other words, the reprinted information is true or has not been tampered with, and the first credential is returned to the information reprinting end to indicate that the information is true or has not been tampered with. If the HASH value of the reprinted information is unequal to that of the first information, it means that the information reprinted on the information reprinting end is untrue or has been tampered with.

In some embodiments of the present application, the Blockchain may be any one of the existing Public Blockchain, Consortium Blockchain, and Private Blockchain, which is not specifically limited to or by exemplary embodiments of the present application.

In the information authentication method provided by the embodiments of the present application, based on the Blockchain, by writing the HASH value and the content information, of the original information or the copy of the original information (the first information), into the Blockchain as the first transaction information, using the characteristics of the Blockchain of distributed storage, decentralization, traceability, immutability and the like, it may be ensured that the HASH value of the first information and content information of the first information are permanently and reliably stored and immutability. In some embodiments of the present application, the HASH value of the reprinted information is compared with the HASH value storing the first information so as to determine if the reprinted information is consistent with the first information released by the original information publishing end, and therefore an efficient and reliable information authentication of the reprinted information is achieved. It effectively solves the problem that the authenticity of the conventional Internet media information may not be proved or problems such as data volume being huge, easy to be tampered with, vulnerable to attacks and the like when information is stored on a central server.

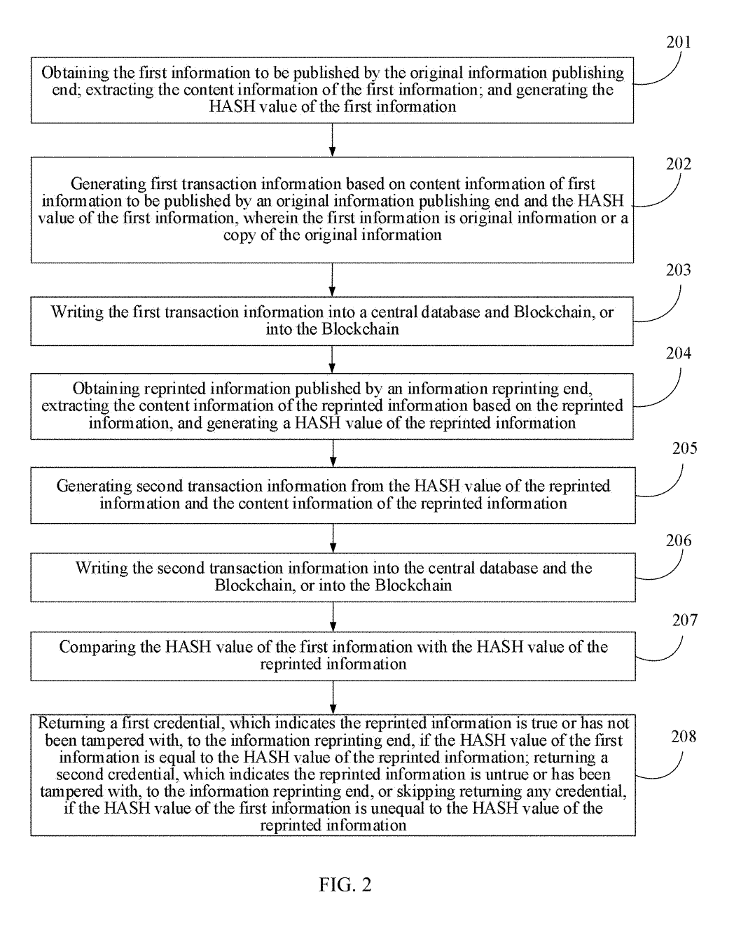

FIG. 2 is a flowchart showing an information authentication method according to another embodiment of the present application. As shown in FIG. 2, the method includes the following steps.

201: Obtaining first information to be published by an original information publishing end; extracting content information of the first information; and generating the HASH value of the first information.

202: Generating first transaction information based on the content information of the first information to be published by the original information publishing end and the HASH value of the first information, wherein the first information is original information or a copy of the original information.

203: Writing the first transaction information into a central database and Blockchain, or into the Blockchain.

201 may be executed before 202 to obtain the first information to be published by the original information publishing end, extract the content information of the first information, and generate the HASH value of the first information.

Step 202 and 203 are similar to step 101 and 102 in the embodiment of FIG. 1 respectively, and will not be repeated redundantly herein.

204: Obtaining reprinted information published by an information reprinting end; extracting the content information of the reprinted information; and generating a HASH value of the reprinted information.

205: Generating a second transaction information from the HASH value of the reprinted information and the content information of the reprinted information.

206: Writing the second transaction information into the central database and the Blockchain, or into the Blockchain.

That is to say, compared with the embodiment shown in FIG. 1, the embodiment of FIG. 2 obtains the HASH value of the reprinted information, and extracts the content information of the reprinted information, and writes the HASH value of the reprinted information and the content information of the reprinted information as the second transaction information into the central database and Blockchain, or into the Blockchain.

Similar with the situation that the first transaction information is written into the central database and the Blockchain, or written into the Blockchain, the entire content of the second transaction information may also be written into the central database, and the HASH value in the second transaction information and the ID in the second transaction information are written into the Blockchain. Meanwhile, the central database may play a role of alleviating the storage pressure of the Blockchain. In the meantime, since the ID usually occupies a small storage space and is important for searching for information, the ID of the reprinted information together with the HASH value in the second transaction information are stored into the Blockchain for permanent storage, which also facilitates the search and trace of information afterwards. In addition, all the content of the second transaction information may also be written into the Blockchain, thereby achieving permanent storage of the HASH value of the second transaction information and the content information of the second transaction information at the same time. In this way, once the reprinted information is published by the information reprinting end, the content information of the reprinted information and the HASH value of the reprinted information are permanently recorded, so that the evidence of the reprinted information generated by the information reprinting end may be saved in the mechanism.

In an embodiment of the present application, the second transaction information further includes a HASH value of the parent transaction of the reprinted information, which may help finding the source of a superior information of the reprinted information.

207: Comparing the HASH value of the first information with the HASH of the reprinted information;

208: Returning a first credential, which indicates the information is true or has not been tampered with, to the information reprinting end, if the HASH value of the first information is equal to the HASH value of the reprinted information; returning a second credential, which indicates the information is untrue or has been tampered with, to the information reprinting end, or skipping returning any credential, if the HASH of the first information is unequal to the HASH of the reprinted information.

The first credential may be represented as a two-dimensional code, a “√” symbol and so on, and be attached to the reprinted information for users to identify. The second credential may be represented as, for example, a “×” symbol, and be attached to the reprinted information as a reminder of the reprinted information being untrue or has being tampered with. In an embodiment of the present application, comparing the HASH value of reprinted information with the HASH value of the first information, if the HASH value of reprinted information is different from the HASH value of the first information, no credential may be returned. Or other results may be obtained as long as it is different from the action of returning a first credential.

In an embodiment of the present application, the method further includes: extracting, from the central data base or the Blockchain, the first transaction information of the first information corresponding to the reprinted information, when the first credential is accessed. The first credential may usually include an access interface connected to the first transaction information. By the accessing to the access interface, one or multiple version information corresponding to the reproduced information, which are published by the original information publishing end, may be queried, thereby further realizing the traceability of news and other information, the comparison and verification of new and old information, and other functions.

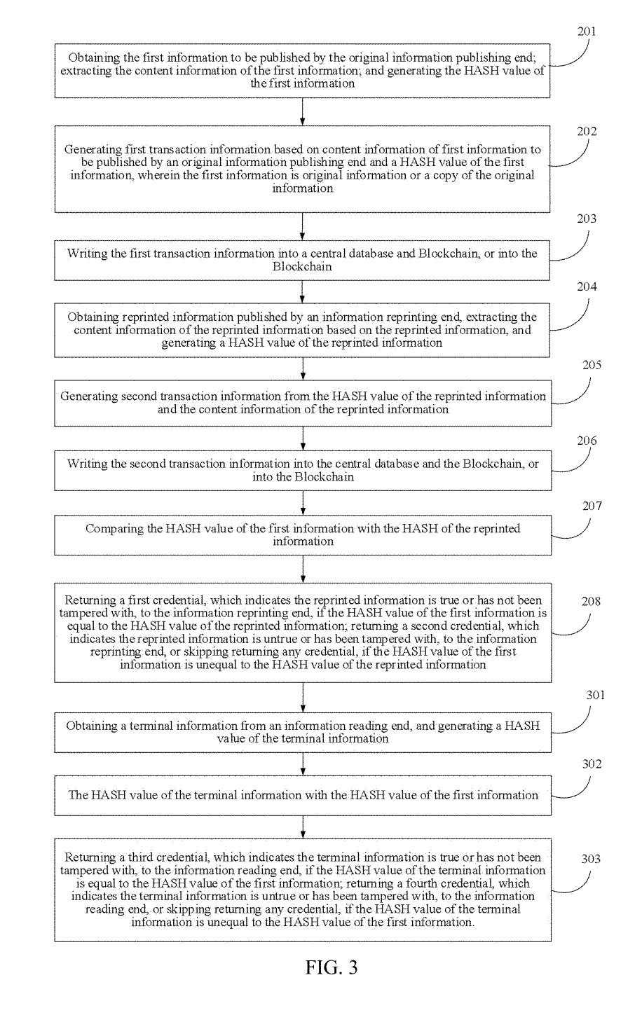

FIG. 3 is a flow chart showing an information authentication method according to another embodiment of the present application. As shown in FIG. 3, on the basis of the embodiments shown in FIG. 2, the method may further include the following steps.

301: Obtaining terminal information from an information reading end; and generating a HASH value of the terminal information.

302: Comparing the HASH value of the terminal information with a HASH value of the first information.

303: Returning a third credential that the terminal information is true or has not been tampered with to the information reading end, if the HASH value of the terminal information is equal to the HASH value of the first information; returning a fourth credential that the terminal information is untrue or has been tampered with to the information reading end, or skipping returning any credential, if the HASH value of the terminal information is unequal to the HASH value of the first information.

In embodiments of the application, in order to further ensure that the terminal information obtained by information reading end is true and has not been tampered with, the HASH value of the terminal information is also compared with the HASH value of the first information to determine whether the terminal information is identical with the first information published by the original information publishing end. And thus the information authentication, verification and identification of the terminal information are accomplished.

The third credential may be represented as a two-dimensional code, a “√” symbol and the like, and may be attached to the terminal information for users to identify. The fourth credential may be represented such as a “×” symbol, and may be attached to the terminal information as a reminder of the terminal information being untrue or has being tampered with.

In an embodiment of the present application, the information authentication method further includes: extracting, from the central database or the Blockchain, a second transaction information of the reprinted information corresponding to the terminal information, when the third credential is accessed.

In a preferred embodiment of the present application, the two-dimensional code, as a representation of the third credential, may include an access interface connected to the second transaction information. A reprinted version information, published by the information reprinting end, corresponding to the terminal information may be inquired through the access interface, thereby realizing the traceability, verification of the reprint of information, and comparison and confirmation the authenticity of forwarding information such as news and the like. In another embodiment of the present application, when the reader of a terminal obtains the third credential, a page of the reprinted information are accessed through the third credential. And while the reprinted version information (the second transaction information) is obtained, a version information of the first information that is the first transaction information and corresponding to the reprinted information, is acquired by further accessing the first credential on the page of the reprinted page. Thereby the traceability of original information and that of the reprinted information, and the comparison between the original information and the reprinted information are achieved.

The above method and its corresponding system will be introduced in specific embodiments of the present application herein, to further illustrate the present application.

Embodiments of the present application provide an authentication system, of which a programming language is Java, which is based on the Blockchain of an IBM hyperledger, and in which Google Chrome is used. In embodiments of the present application, the information to be authenticated and traced is news.

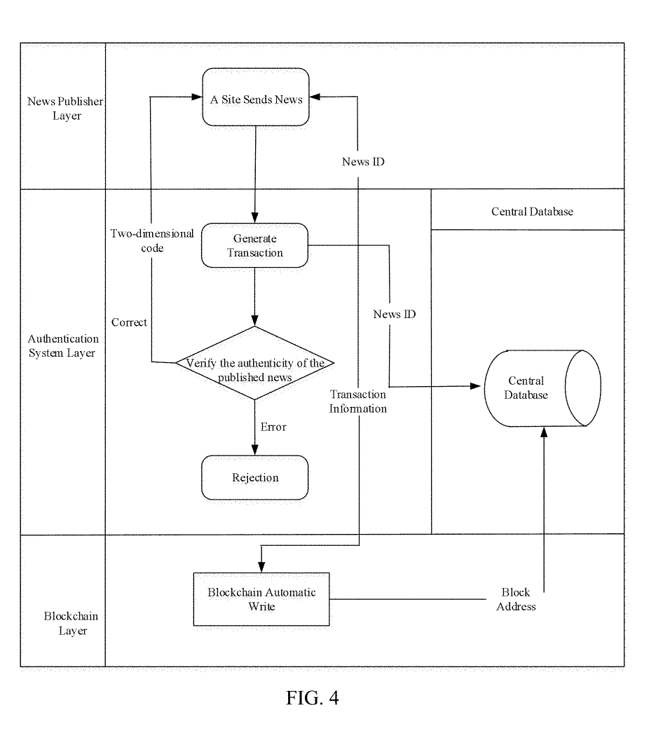

FIG. 4 shows a specific operation process of an original information publishing end and that of an information reprinting end according to embodiments of present application, which runs in an architecture including a news publisher layer, an authentication system layer, and a Blockchain layer.

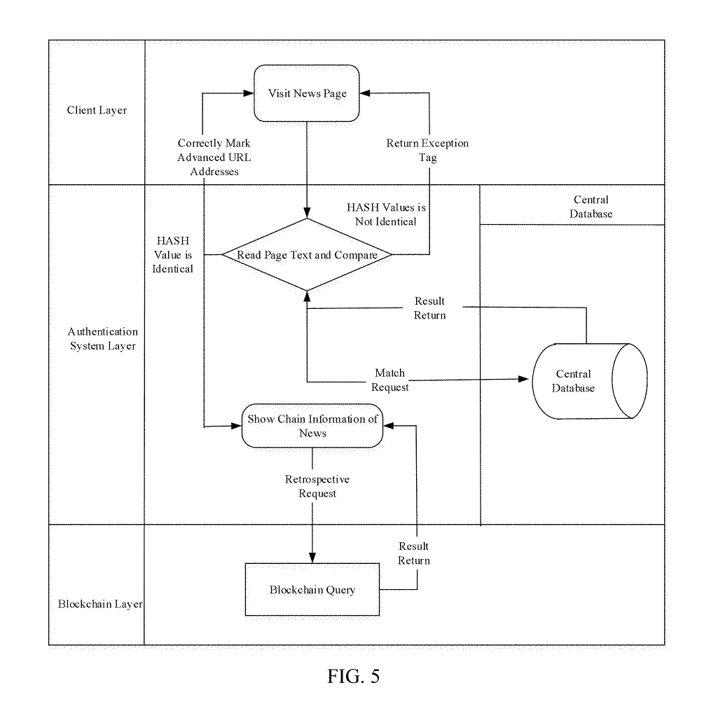

FIG. 5 shows a specific operation process of an information reading end, which runs in an architecture including a client layer, an authentication system layer, and a Blockchain layer.

Referring to FIG. 1 to FIG. 5, the operation process of the information authentication system based on Blockchain, provided in embodiments of the present application, includes the following steps.

110: The system obtains first information to be published by an original information publishing end, wherein the first information may include an original information or a copy of the original information specifically.

120: Based on the first information, the system generates the HASH value of the first information using HASH algorithm and extracts content information of the first information.

The content information may include an ID, a tittle, content, an author, a date and a posting site name of information.

The steps of 110 and 120 may be implemented before the step of “A site sends news” in FIG. 4.

The first information of embodiments of the present application is as shown in table 1.

TABLE 1
the content information of the first information

| News | News | News | News | | News Posting |
|---|---|---|---|---|---|
| ID | Tittle | Content | Author | News Date | Site Name |
| 10001 | Apply | This is an | Me | 2017-03-14 | Name of the site |
| | | apply | | 09:27:39.0 | |

130: The system generates the first transaction information from the content information and the HASH value of the first information.

This step may be implemented in the step of “generate transaction” in FIG. 4.

The first transaction information of embodiments of the present application may include transaction ID “55b8e2a3-f903-430d-bc96-7cc601319a17” and transaction content “CpYCCAESgwESgAE2YjgxODg0YWFkNGFmNWY5YmE4NzUyMWM5N2M4ZDY1ZD QxYjVhMTJjYzFjZjBmOTk4MDkzZDY5MTUyYzU2NWFhOGIyOGM3OWJhZjI0MzI0Z GYwOGZjZGFjMmR1NDdjMzY3MGRiMTM2MGExODJmZjY0ZGIyOTQ5ZThlODM0ZG RmMxqLAQoKY3JlYXR1TmV3cwoFMTAwMDEKBkFwbHBseQoBMQoQdGhpcyBpcyB hbiBhcHBseQpAODJmOWRkYzZkNWFmODglNjU2NzQwZmZiMjhiYjg4NjIyZTRhNTM yNWN1ZTB1ZGIyZjI3MzMOMjA4OTViY2MwOQoCbWUKEzIwMTctMDMtMTQgMDk6Mjc6Mzk=”.

140: The system writes the first transaction information into a center database and Blockchain. The entire content of the first transaction information is written into the center database, and the ID in the first transaction information and HASH value in the first transaction information are written into the Blockchain. The Blockchain scan transaction every 15 seconds. A new transaction may be written into the Blockchain, when the new transaction is scanned.

This step may be implemented in processes of “generate transaction to the center database” and “Blockchain automatic write” in FIG. 4.

In an embodiment of the present application, the above steps 110 to 140 may skip performing the process from “verify the authenticity of the published news” to the process of “site send news” and skip the step of “rejection” in FIG. 4. Yet, in other embodiments of the present application, the above skipped steps may be run to verify the original information published by the original information publishing end.

150: The system obtains reprinted information published by an information reprinting end; the system extracts the content information of the reprinted information based on the reprinted information; the system generates a HASH value of reprinted information with the HASH algorithm. In addition, the system generates a second transaction information from the HASH value and content information of the reprinted information, and writes the second transaction information into the central database and the Blockchain, wherein the second transaction information further includes a HASH value of a parent transaction of the reprinted information.

The content information includes an ID of information, a tittle of the information, a content of the information, an author of the information, a date of the information and a posting site name of the information and so on. The entire content of the second transaction information is written into the center database, and the system also writes the HASH value and the ID in the second transaction information into the Blockchain. The Blockchain scan transaction in every 15 seconds. A new transaction may be written into the Blockchain, when the new transaction is scanned.

This step may be implemented before the step that “a site sends news”, and in the steps that “a site sends news”, “generate transaction to the center database” and “Blockchain automatic write” in FIG. 4.

160: The system compares a HASH value of the reprinted information with a HASH value of the first information, and a first credential that indicates information is true or has not been tampered with is returned to the information reprinted terminal, if the HASH value of the reprinted information is equal to the HASH value of the first information. The system returns a second credential that is used to inform information is not true or has been tampered with to the information reprinted terminal, or skip returning any credential. The first credential is represent as a two-dimensional code.

This step is implemented in the steps from “verify the authenticity of the published news” to “site send news” and the step of “rejection” in FIG. 4.

170: The system obtains, by the terminal information from the information reading end, and the system uses HASH algorithm to generate a HASH value of the terminal information. And the system compares the HASH value of the terminal information with the HASH value of the first information. The system returns a third credential that indicates information is true or has not been tampered with to the information reading end, if the HASH value of terminal information is equal to the HASH value of the first information; the system returns a forth credential that symbolizes information is untrue or has been tampered with to the information reading end, or skipping returning any credential, if the HASH value of terminal information is unequal to the HASH value of the first information. The third credential is represented as a two-dimensional code.

This step is processed in the client layer and the authentication system layer of FIG. 5.

180: The system obtains the first transaction information of the first information corresponding to the terminal information from the central database or Blockchain, with access to the first credential.

This step is processed in the Blockchain layer of FIG. 5.

In embodiments of the present application, the foregoing steps 170 and 180 correspond to the reading end, and may specifically include the following steps.

A: The reader clicks news from the information reading end, and at the same time, a terminal news text, as the terminal information, is automatically acquired with the system plug-in.

B: Sending a matching request to the central database, and comparing the HASH value of the news, the abstract of the news, the ID of the news and other information. If the match is successeful, the system returns a correct mark as the third credential; otherwise, the system returns an error flag as the fourth credential, or does not return any flag.

C: The reader enters the information reprint interface, if the correct mark is returned. With access to the first credential returned by the system, the detailed information stored in the Blockchain, such as the version of the news, the citation and the like, may be obtained. The version of the current news may be known, and the original version or the latest version of the current news may be found.

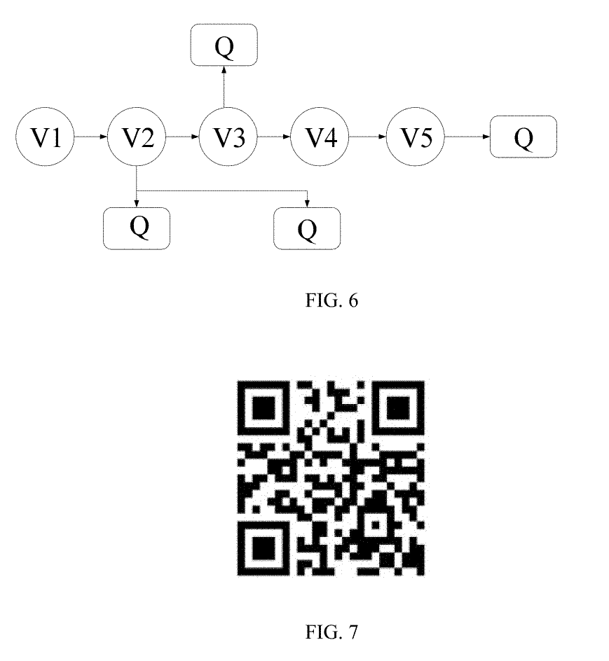

FIG. 6 shows a part of a transaction information acquired by an information authentication system provided by the embodiment of the present application after accessing the first credential and the third credential at runtime. In the above A to C step, a part of the transaction information obtained after accessing the credential is as shown in FIG. 6, wherein V1 to V5 are respectively version information published by five different original information publishing ends, and Q is reprinted information published by the information reprinting end.

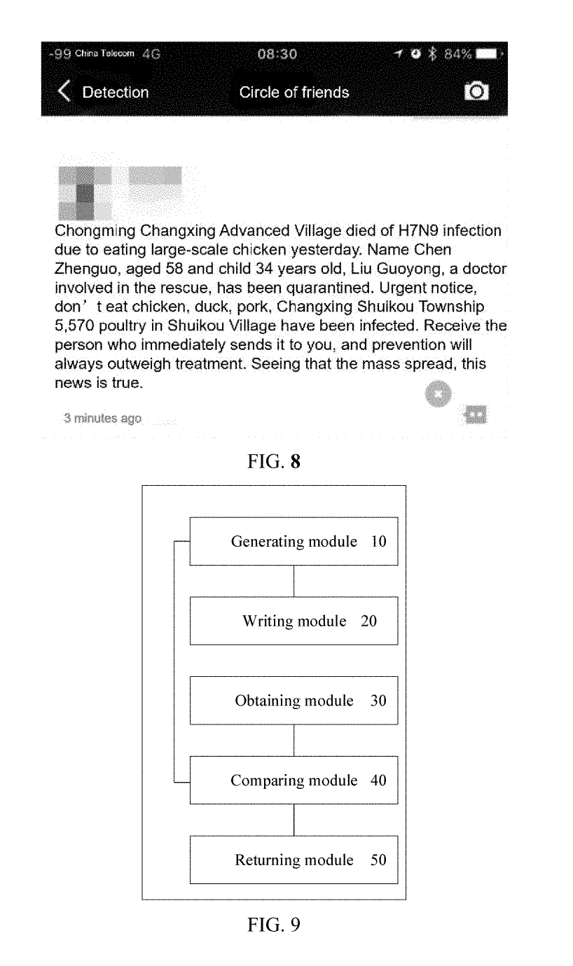

FIG. 7 shows a credential generated by an information authentication system at its runtime according to an embodiment of the present application, wherein the credential is a two-dimensional code. FIG. 8 shows a running result of an information authentication system on an information reading end, according to an embodiment of the present application, wherein the circled symbol “×” in the figure is an error flag. For a correct mark, it may be represented as the circled symbol “√”.

The embodiments of the present application further provide an information authentication system corresponding to the above information authentication method. As shown in FIG. 9, in an embodiment of the present application, the information authentication system includes: a generating module 10, a writing module 20, an obtaining module 30, a comparison module 40, and a returning module 50.

A generating module 10 is configured to generate first transaction information based on content information of the first information to be published by an original information publishing end and a HASH value of the first information, wherein the first information is a copy of original information or the original information.

A writing module 20 is configured to write the first transaction information generated by the generating module 10 into a central database and Blockchain, or the Blockchain;

An obtaining module 30 is configured to obtain reprinted information issued by an information reprinting end and generate a HASH value of the reprinted information;

A comparing module 40 is configured to compare the HASH value of the reprinted information with the HASH value of the first information; and

A returning module 50 is configured to return a first credential that the information is true or has not been tampered with to the information reprinting end, if the HASH value of the first information is equal to the HASH value of the reprinted information. In another embodiment of the present application, the returning module 50 is further configured to return a second credential that the information is untrue or has been tampered with to the information reprinting end, or skip returning any credential, if the HASH value of the first information is not identical to the HASH value of the reprinted information.

In the information authentication system provided by embodiments of the present application, the first transaction information is generated by the generating module and written by the writing module into the Blockchain, and the distributed storage, decentralization, traceability, and immutability of the Blockchain are utilized. Thus it is ensured that the HASH value of the first information and content information of the first information are permanently and reliably stored and may not been tampered with. In some embodiments of the present application, the comparing module compares the HASH value of the reprinted information with the HASH value of the first information stored in the Blockchain to determine if the reprinted information is consistent with the first information released by the original information publishing end, and therefore an efficient and reliable information authentication for reprinted information is achieved. The problems, such as the authenticity of the existing Internet media information cannot be verified or huge amounts of data, being easily tampered with or being attacked when information is stored on a central server, may be solved effectively.

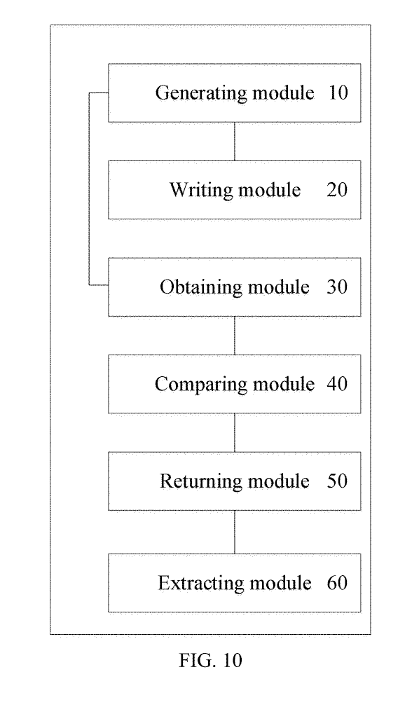

FIG. 10 is a structural diagram of an information authentication system according to another embodiment of the present application. As shown in FIG. 10, the information authentication system further includes an extracting module 60 based on the embodiments shown in FIG. 9.

In embodiments of the present application, the obtaining module 30 is further configured to obtain first information to be published by an original information publishing end, extract the content information of the first information, and generate a HASH value of the first information, so that the generating module 10 may generate first transaction information based on the content information of the first information and the HASH value of the first information acquired by the obtaining module 30.

In an embodiment, the obtaining module 30 is further configured to obtain reprinted information and extract the content information of the reprinted information, and the generating module 10 is further configured to generate second transaction information from the HASH value of the reprinted information and the content information of the reprinted information. Then the second transaction information is written into a central database and Blockchain, or into the Blockchain by the writing module 20. In one embodiment, the second transaction information further includes a HASH value of the parent transaction of the reprinted information which may help to find the source of a superior information of the reprinted information.

The extracting module 60 is configured to extract, from the central database or the Blockchain, the first transaction information of the first information corresponding to the reprinted information, when the first credential is accessed. The first credential generally includes an access interface connected to the first transaction information. By accessing the access interface, the version information published by one or more original information publishing ends corresponding to the reprinted information may be queried, thereby further implementing the traceability of information, such as news, the comparison and verification of new and old information.

In the information authentication system provided by the embodiment of the present application, the obtaining module obtains the HASH value of the reprinted information, and extracts the content information of that, and the generating module generates the HASH value of the reprinted information and the content information of the reprinted information as the second transaction information which is further written into the Blockchain by the writing module, thereby realizing the permanent storage of the HASH value of the second transaction information and the content information of the second transaction information at the same time. And thus the evidence of the reprinted information generated by the information reprinting end is saved from the mechanism. In addition, the embodiments of the present application enables the user to query the version information published by the original information publishing end corresponding to the reprinted information by accessing the first credential, thereby realizing functions of the traceability of information such as news, and the comparison and verification of old information and new information and the like.

In another embodiment of the present application, the obtaining module 30 is further configured to acquire terminal information from the information reading end and generate a

HASH value of the terminal information. The comparison module 40 is further configured to compare the HASH value of the terminal information with the HASH value of the first information. The returning module 50 is further configured to return a third credential indicating that the information is true or has not been tampered with to the information reading end, when the HASH value of the terminal information is the same as the HASH value of the first information. In an embodiment, the returning module 50 is further configured to return a fourth credential indicating that the information is untrue or tampered with to the information reading end, or skip returning any credential, when the HASH value of the terminal information is unequal to the HASH value of the first information.

The extracting module 60 is further configured to extract the second transaction information of the reprinted information corresponding to the terminal information from the central database or the Blockchain, when the third credential is accessed.

In the authentication system provided by the embodiments of the present application, the terminal information of the information reading end is obtained by the obtaining module, the comparing module and the returning module. It is determined whether the terminal information is consistent with the first information, according to the comparison result between the HASH value of the terminal information and the HASH value of the first information, which may further ensure that the terminal information obtained by the information reading end is true or has not been tampered with, and accomplish the information authentication, verification and identification of the terminal information. In addition, the embodiments of the present application use the extracting module to enable the terminal user to obtain the reprinted version information published by the information reprinting end corresponding to the terminal information by accessing the third credential, thereby realizing the traceability, verification of information such as news and the like forwarding. And other functions such as the comparison and verification of forwarding information of may also be achieved.

In an embodiment of the application, the first credential and the third credential may be preferably represented as a two-dimensional code. The content information may generally include at least one of an ID of information, a title of the information, a content of the information, an author of the information, a date of the information, and a posting site name of the information, wherein the ID of the information may include an original link address of the information. The content information may be searched in combination with HASH values to improve retrieval efficiency, and may be recorded by saving for further viewing and verification.

The information authentication system described in the embodiment of the present application is implemented based on a Blockchain network, and the Blockchain network may be any one of Public Blockchain, Consortium Blockchain, and Private Blockchain. The information authentication system provided by the embodiment of the present application corresponds to the information authentication method described in the foregoing embodiment. The functions and specific settings of each functional module may refer to the description of each step in the embodiments of the method, and the details of which will not be redundantly described herein.

An embodiment of the present application further provides a computer device, which includes a processor and a memory storing computer programs that, when executed by the processor, cause the processor to perform the steps of the method as described in any of the preceding embodiments.

An embodiment of the present application further provides a computer readable storage medium, which stores computer programs that, when executed by a processor, cause the processor to perform the steps of the method as described in any of the preceding embodiments. The computer storage medium may be any tangible medium such as a floppy disk, CD-ROM, DVD, hard drive, network medium or the like.

It should be understood that, although an implementation form of the embodiments of the present application described above may be a computer program product, the method or apparatus of the embodiments of the present application may be implemented by software, hardware, or a combination of software and hardware. The hardware carrier may include node devices, mobile terminals, etc. of Blockchain network; the software portion can be stored in memory and executed by a suitable instruction execution system, such as a microprocessor or dedicated design hardware. It can be clearly understood by persons of ordinary skill in the art the methods and apparatus described above may be implemented using computer-executable instructions and/or embodied in processor control code. Such code or instructions may be provided on a carrier medium such as a magnetic disk, CD or DVD-ROM, a programmable memory such as a read-only memory (firmware) or on a data carrier such as an optical or electronic signal carrier. The method and apparatus of the present application may be implemented by hardware circuits such as very large scale integrated circuits or gate arrays, semiconductors such as logic chips, transistors, etc. or programmable hardware devices such as field programmable gate arrays, programmable logic devices, etc., or may also be implemented by software executed by various types of processors, or by a combination of the above-described hardware circuits and software such as firmware.

It should be understood that, although several modules of the devices have been mentioned in the above detailed description, this division is merely exemplary and not mandatory. In fact, according to an exemplary embodiment of the present application, the features and functions of the two or more modules described above may be implemented in one module, whereas the features and functions of one of the modules described above may be further divided to be implemented by multiple modules. Moreover, some of the modules described above may be omitted in certain application scenarios.

It should be understood that, the description of the embodiments of the present application only describes the key and essential techniques and features of the methods and devices above, in order not to obscure the solutions of the present invention, and some features of the present application that can be implemented by those skilled in the art may be possibly unexplained.

The foregoing descriptions are only the preferred embodiments of the present application and are not intended to limit the scope of the present application. Any modifications, equivalent substitutions, improvements, etc. made within the spirit and principles of the present application should be included within the scope of the present application.

What is claimed is:

1. An information authentication method, comprising:
generating first transaction information based on content information of first information to be published by an original information publishing end and a HASH value of the first information, wherein the first information is original information or a copy of the original information;
writing the first transaction information into a central database and Blockchain, or into the Blockchain;
obtaining reprinted information published by an information reprinting end, and generating a HASH value of the reprinted information;
comparing the HASH value of the first information with the HASH value of the reprinted information; and
returning a first credential, which indicates the reprinted information is true or has not been tampered with, to the information reprinting end, if the HASH value of the first information is equal to the HASH value of the reprinted information.

2. The information authentication method according to claim 1, before generating first transaction information based on content information of first information to be published by an original information publishing end and a HASH value of the first information, the method further comprises:
obtaining the first information to be published by the original information publishing end;
extracting the content information of the first information; and
generating the HASH value of the first information,
wherein the information authentication method further comprises:
returning a second credential, which indicates the reprinted information is untrue or has been tampered with, to the information reprinting end, or skipping returning any credential, if the HASH value of the first information is unequal to the HASH value of the reprinted information.

3. The information authentication method according to claim 1, wherein the obtaining reprinted information published by an information reprinting end, and generating a HASH value of the reprinted information further comprises:
extracting content information of the reprinted information based on the reprinted information,
wherein after the generating a HASH value of the reprinted information, the information authentication method further comprises:
generating second transaction information from the HASH value of the reprinted information and the content information of the reprinted information;
writing the second transaction information into the central database and the Blockchain, or into the Blockchain.

4. The information authentication method according to claim 3, wherein writing entire content of the first transaction information or the second transaction information into the Blockchain, when writing the first transaction information or the second transaction information into the Blockchain;
writing entire content of the first transaction information into the central database and writing the HASH value in the first transaction information and an ID in the first transaction information into the Blockchain, or writing entire content of the second transaction information into the central database and writing the HASH value in the second transaction information and an ID in the second transaction information into the Blockchain, when writing the first transaction information or the second transaction information into the Blockchain and the central database.

5. The information authentication method according to claim 3, wherein the second transaction information further comprises a HASH value of a parent transaction of the reprinted information.

6. The information authentication method according to claim 1, further comprising:
extracting, from the central data base or the Blockchain, the first transaction information of the first information corresponding to the reprinted information, when the first credential is accessed.

7. The information authentication method according to claim 1, further comprising:
obtaining terminal information from an information reading end, and generating a HASH value of the terminal information;
comparing the HASH value of the terminal information with the HASH value of the first information; and
returning a third credential, which indicates the terminal information is true or has not been tampered with, to the information reading end, if the HASH value of the terminal information is equal to the HASH value of the first information.

8. The information authentication method according to claim 7, further comprising:
returning a fourth credential, which indicates the terminal information is untrue or has been tampered with, to the information reading end, or skipping returning any credential, if the HASH value of the terminal information is unequal to the HASH value of the first information.

9. The information authentication method according to claim 7, further comprising:
extracting, from the central database or the Blockchain, the second transaction information of the reprinted information corresponding to the terminal information, when the third credential is accessed.

10. The information authentication method according to claim 7, wherein the first credential and the third credential are represented as a two-dimensional code.

11. The information authentication method according to claim 1, wherein the content information comprises: at least one of an ID of information, a title of the information, a content of the information, an author of the information, a date of the information, and a posting site name of the information.

12. An information authentication system, comprising:
a processor; and
a memory storing a computer program executable by the processor,
wherein the processor is configured to:
generate first transaction information based on content information of first information to be published by an original information publishing end and a HASH value of the first information, wherein the first information is original information or a copy of the original information;
write the first transaction information generated by the generating module into a central database and Blockchain, or into the Blockchain;
obtain reprinted information published by an information reprinting end, and generate a HASH value of the reprinted information;
compare the HASH value of the first information with the HASH value of the reprinted information; and
return a first credential, which indicates the reprinted information is true or has not been tampered with, to the information reprinting end, if the HASH value of the first information is equal to the HASH value of the reprinted information.

13. The information authentication system according to claim 12, wherein the processor is further configured to:
obtain the first information to be published by the original information publishing end, extract the content information of the first information, and generate the HASH value of the first information;
return a second credential, which indicates the reprinted information is untrue or has been tampered with, to the information reprinting end, or skip returning any credential, if the HASH value of the first information is unequal to the HASH value of the reprinted information.

14. The information authentication system according to claim 12, wherein the processor is further configured to:
extract content information of the reprinted information based on the reprinted information;
generate second transaction information from the HASH value of the reprinted information and the content information of the reprinted information; and
write the second transaction information into the central database and the Blockchain, or into the Blockchain.

15. The information authentication system according to claim 14, wherein the processor is configured to:
write entire content of the first transaction information or the second transaction information into the Blockchain, when writing the first transaction information or the second transaction information into the Blockchain;
write entire content of the first transaction information into the central database and write the HASH value in the first transaction information and an ID in the first transaction information into the Blockchain, or write entire content of the second transaction information into the central database and write the HASH value in the second transaction information and an ID in the second transaction information into the Blockchain, when writing the first transaction information or the second transaction information into the Blockchain and the central database.

16. The information authentication system according to claim 12, wherein the processor is further configured to: extract, from the central data base or the Blockchain, the first transaction information of the first information corresponding to the reprinted information, when the first credential is accessed.

17. The information authentication system according to claim 12, wherein the processor is further configured to:
obtain terminal information from an information reading end, and generate a HASH value of the terminal information;
compare the HASH value of the terminal information with the HASH of the first information; and
return a third credential, which indicates the terminal information is true or has not been tampered with, to the information reading end, if the HASH value of the terminal information is equal to the HASH value of the first information.

18. The information authentication system according to claim 17, wherein the processor is further configured to: return a fourth credential, which indicates the terminal information is untrue or has been tampered with, to the information reading end, or skip returning any credential, if the HASH value of the terminal information is unequal to the HASH value of the first information.

19. The information authentication system according to claim 17, wherein the processor is further configured to: extract, from the central database or the Blockchain, the second transaction information of the reprinted information corresponding to the terminal information, when the third credential is accessed.

20. A computer readable storage medium storing a computer program that, when executed by a processor, causes the processor to:
generate first transaction information based on content information of first information to be published by an original information publishing end and a HASH value of the first information, wherein the first information is original information or a copy of the original information;
write the first transaction information into a central database and Blockchain, or into the Blockchain;
obtain reprinted information published by an information reprinting end, and generate a HASH value of the reprinted information;
compare the HASH value of the first information with the HASH value of the reprinted information; and
return a first credential, which indicates the reprinted information is true or has not been tampered with, to the information reprinting end, if the HASH value of the first information is equal to the HASH value of the reprinted information.
